(19) United States
(12) Patent Application Publication
(10) Pub. No.: US 2020/0028994 A1
(43) Pub. Date: Jan. 23, 2020

(54) WEBCAM SHIELD

(71) Applicant: Anil Rami, Hilo, HI (US)

(72) Inventor: Anil Rami, Hilo, HI (US)

(21) Appl. No.: 16/036,970

(22) Filed: Jul. 17, 2018

(51) Int. Cl. H04N 5/225

(52) U.S. Cl. CPC H04N 5/2251

(57) ABSTRACT

A webcam shielding article or a webcam shield to provide protection from camfecting is described herein. The webcam shield comprises a displaying surface or front surface and a permanent attachment surface or rear surface; wherein the rear surface of the webcam shield further includes a shielding portion which partially adheres to the lens of the webcam to provide protection from camfecting and lets that adhesion go for opening by its own material makeup while camera is in use, an attachment portion from where the webcam shield get attached beside the lens of the camera, and an attachment member preferably, but not limited to, adhesive tape to attach the webcam shield from the device tightly. While the displaying surface of the shield which is visible while attached to the webcam may include any pleasant design, images, logo or the name. The attachment surface of the shield at the shielding portion includes large number of microscopic craters that work by creating many partial vacuums between the shielding portion of the attachment surface and the lens of the webcam which is not pressure sensitive and thus allows user to detach and attach the shielding portion from the lens of the camera. Further the shielding portion of the webcam shield is made of a material having static clinging characteristic that provides additional adhesion while coupling with the lens of the camera.

### FIELD OF THE INVENTION

The present invention relates to the cover or a shield for the webcam to provide security from camfecting. More completes specification can be given as it is specially designed webcam cover for the webcams of smartphones, laptops, tablets or desktop computers that can protect the front and rear camera of the device from the hackers as well as to protect the camera from dust and damage. Wherein the said webcam cover is made of a material that uses Nano suction to cling on the glass or similar cohesive surface of the webcam of devices.

### BACKGROUND OF THE INVENTION

In last few years there have been noticeable increment in number of features in the devices such as smartphones, laptops, tablets personal computers or any other devices with webcam, and also there is an increment in popularity of such devices that makes the world smaller by allowing user to engage in interactive visual video communication with any person in the world, click pictures, make videos etc. A common procedure to use the webcam for such purposes is by allowing the applications or software manually by user which in turns accesses the webcam for providing facility of video chat or video conferencing, picture clicking, learning, etc. The disadvantage of such technology is the exposure of Camfecting the hackers got, which is the process of attempt to hack into any person's webcam and activate it without the permission of that person. This hacking can be done remotely from the device in the next room, in the same are/city or from anywhere in the world by simply using internet network connection and malware.

The remotely activated webcam can be used to watch anything within the vision of the webcam. It can be used to record, analyze, use and share spy data of use of certain device at a given time frame, to spy what one or more people are doing, what is located and going on in certain places, where valuable objects are located, when and why things are happening, to know competitor's business activities, intellectual property and secret projects. This also opens up the possibility of cyber stalking, blackmail and voyeurism.

Camfecting is usually carried out by infecting any of the above mentioned device of the victim with a malware such as, but not limited to, viruses, worms, backdoors, adware, spyware, Trojan, RAT (Remote Access/Administration Tool), spam sending malware, ransom ware, etc. that provides the hacker access to the webcam of victim's device. Typically, the hacker sends the malware hidden in the innocent-looking application or link or advertisement, by installing which unintentionally and unknowingly within the device, the victim him/herself gives access of their webcam to the hacker to turn on the webcam and capture pictures/videos.

This has led to the development of various devices designed to prevent unwanted recording of images and videos even if the device has been hacked. One such effort is disclosed in US 20160105598A1 which describes a system and method for embodiment of a network video camera with a blocking mechanism for privacy and control of the blocking mechanism. Embodiment of the invention includes a network video capture device comprises a lens connected to a housing; a blocking mechanism, wherein the blocking mechanism is configured to selectively block the lens from capturing video images, and wherein the blocking mechanism includes a physical body; an indication device configured to provide visible feedback that the lens is blocked; and a circuit board having a data processor, a wireless transceiver, and a memory configured to store a customizable setting associated with the blocking mechanism. As the system uses electronic drive circuit to monitor and to block the camera and as its operations are controlled by the drivers and software stored in the memory, they do not provide sufficient guarantees for end users since safe functioning of the software based operation cannot be guaranteed. Further it is complex in nature.

To solve this problem, several mechanical and electromagnetic shielding devices that can be attached to the lens of the webcam to obstruct the field of the view have been developed. Such shielding devices can be any of a sliding shielding cover located in from of the camera lens, a pivotal shielding device pivots around the pivot point to cover or uncover lens, a shielding device hinged over the lens to cover or uncover the lens, a shield hangs upon the hook located above the lens or can be electromagnetic driven camera shielding cover.

There are no known shielding devices for webcams that uses nano-suction cling technology combined with a permanent adhering member to easily adhere to the glass of the webcam and smartphone camera without left behind residue on the lens of the camera. Also, there is a need for an economical, effective shielding device for webcam that can be manufactured in large quantities at relatively low cost, with minimal size and configuration variations that is easy to use and does not impede the operation of the electronic device to which it is attached.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The present invention discloses an improved design of a shield or cover for webcam that overcomes the abovementioned need for an article that uses Nano-suction technology to adhere temporarily over the lens of the webcam for closing it to provide safety from the camfecting. The present invention according to an embodiment of the invention comprises; a main body of the shield having front/displaying surface and rear/attachment surface, wherein the front surface of the shield may have any artistic micro design, pleasant image, logo or the name because of visibility of this surface when shield is attached to the camera. While the rear surface of the shield comprises a shielding portion, a permanent attachment portion and a permanent attachment member, wherein the shielding portion of the rear surface of shield contains large number of Nano-suctions or in other words, it contains a large number of microscopic craters that works by creating many partial vacuum between the shielding portion and the surface on which it is being attached which is a lens of the webcam in this case. The attachment portion of the webcam shield which includes an attachment member, superimposed over the attachment portion, to provide permanent attachment of the shield beside the lens of the camera such that the shielding portion of the shield can be perfectly fit over and cover the lens properly when needed. Moreover, said attachment member of the webcam shield is any of adhesive tape for example 3M tape that allows tight and permanent adhesion of shield to the webcam device.

The object of the present invention is to provide a webcam cover that uses Nano suction to adhere to the glass, lens or surface surrounding the webcam or camera of smartphone.

One another object of the invention is to provide webcam shield that sticks on the surface of the webcam without being sticky.

Yet another object of the present invention is to provide webcam shield that does not leave residue on the lens of the camera after being detached from the lens.

Yet another object of the present invention is to provide a webcam shield with an ultrathin profile with just 0.2 mm or less thickness that easily allows perfect closing of the laptop with the webcam shield attached over the webcam, and also suitable for any smartphones even with their protective covers.

Yet another object of the present invention is to provide a webcam shield that is capable of being attached to cameras of any webcam device such as laptop, smartphone, tablet or webcam of personal computer or any personal digital assistant.

One more object of the present invention is to provide a webcam shield that is durable and long lasting and also does not easily swipe off from smart phone even with its use in pockets and tight spaces.

The foregoing and other objects, features and advantages of the invention will be apparent from the following more particular descriptions of exemplary embodiments of the invention.

### BRIEF DESCRIPTION OF THE DRAWINGS

FIG. 1A exemplarily illustrates Front view of the webcam shields of front facing camera/Selfie camera of smartphones according to one embodiment of the invention.

FIG. 1B exemplarily illustrates Rear view of the webcam shields of front facing camera/Selfie camera of smartphones according to one embodiment of the invention.

FIG. 2A exemplarily illustrates Front view of the webcam shields for rear camera of the smartphone according to one embodiment of the invention.

FIG. 2B exemplarily illustrates Rear view of the webcam shields for rear camera of the smartphone according to one embodiment of the invention.

FIG. 3A exemplarily illustrates webcam shield attached on the back of the smartphones to cover the front facing camera.

FIG. 3B exemplarily illustrates a webcam shield for front facing camera in open position.

FIG. 3C exemplarily illustrates a webcam shield for front facing camera in closed position.

FIG. 4 exemplarily illustrates a smartphone with webcam shield attached to the rear camera of smart phone in closed position.

### DETAILED DESCRIPTION

Detailed embodiment of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

This patent describes the subject matter for patenting with specificity to meet statutory requirements. However, the description itself is not intended to limit the scope of this patent. The principles described herein may be embodied in many different forms.

Illustrative embodiments of the invention now will be described more fully hereinafter with reference to the accompanying drawings in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refers to like elements throughout.

The present invention provides a webcam shield or cover specially designed for electronic devices with camera or webcam such as smartphone, laptop, tablet or personal computers, etc. that uses Nano suction technology to be attached and cover the lens of the camera while camera is not in use, hence eliminates the chances of camfecting as well as protects the lens of the camera from scratch, dust and damage.

Wherein ‘Camfecting’ is the process used by the hackers to hack the webcam of any person and activate the webcam remotely from any location in the world without the permission and even without knowledge of the owner. It is normally carried out by infecting the webcam device of the victim with a malware that can provide access of webcam to the hacker.

According to one embodiment of the invention the webcam shield includes a main body having front surface/displaying surface and rear surface/attachment surface, wherein the attachment surface of the webcam shield further includes a shielding portion, a permanent attachment portion and a permanent attachment member superimposed over the permanent attachment portion. The displaying surface which is visible while webcam shield is attached to the lens of the camera may include any artistic design, pleasant picture/image, name or the logo. A permanent attachment member further includes removable backing which is releasably attached over the surface from which it is being attached to the camera. This removable backing protects adhesive surface of the attachment member till the time of attachment of it to the webcam device.

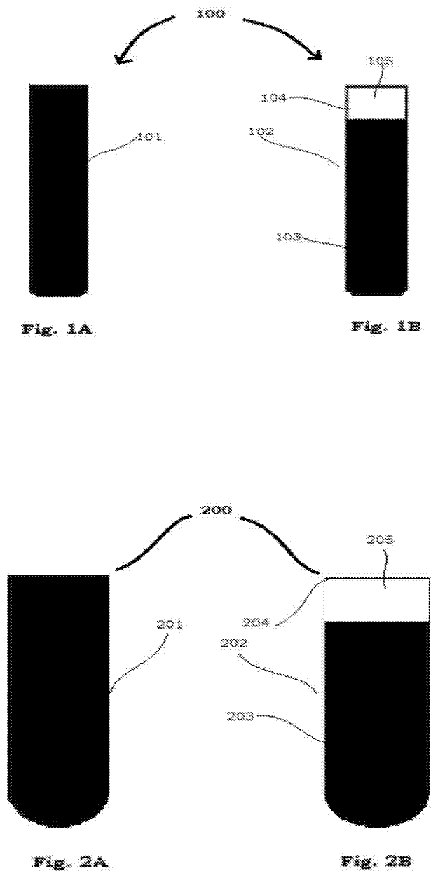

Now, FIG. 1A exemplarily illustrates the displaying surface or front surface 101 of the webcam cover 100 according to one embodiment of the invention specifically designed for the front camera of the smartphones which may include (not shown) any artistic design, logo, name, etc. While FIG. 1B exemplarily illustrates the attachment surface 102 of the webcam cover 100 that contains the shielding portion 103 having large number of large number of Nano-suctions or we can say that it contains a large number of microscopic craters that while pressed over the surface to be attached, creates many partial vacuum between the shielding portion 103 and the surface on which it is being attached which is a lens of the webcam in this case, and by using suction of the generated vacuum it gets removably attached to the surface of the lens. Moreover, the webcam shield 103 is made of a material, such as, but not limited to, polymer Nano-materials which also shows tendency to cling to materials of similar cohesive force or surface.

The permanent attachment portion 104 of the webcam shield 100 is at opposite end from the shielding portion 103 of the webcam cover 100. The permanent attachment portion 104 is a portion from where said webcam shield 100 get attached to the webcam devices permanent. Wherein the webcam shield 100 includes permanent attachment member 105 superimposed over the permanent attachment portion 104 which allows permanent attachment of the attachment portion 104 hence the webcam shield 100, partially to the webcam device. The permanent attachment member 105 is more preferably, but not limited to, the unconventional foam tape such as double sided 3M tape that adhere on the permanent attachment portion 104 from one side and to the webcam device from the other side. The adhesion side of the permanent attachment member 105 from where it get attached to the webcam device further comprises a removable backing (not shown), releasably attached over it to protect the adhesive surface of the permanent attachment member 105 from dust till its attachment to the webcam device.

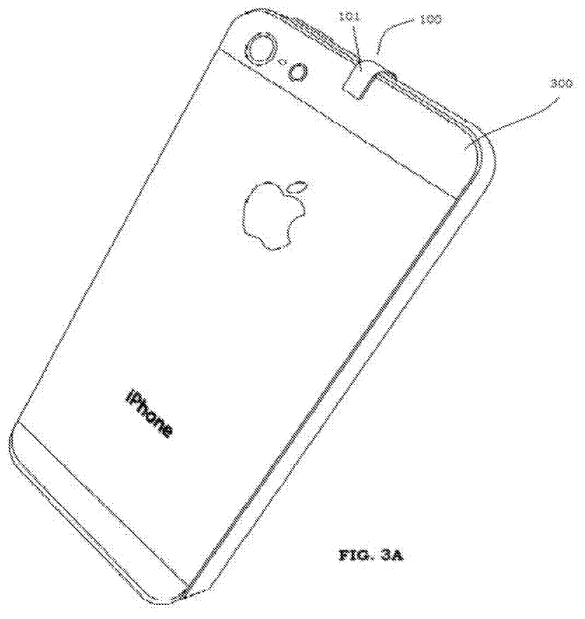

FIG. 2A and FIG. 2B ate another exemplary embodiments of the present invention with slight change in dimensions without departing from the scope and spirit of the invention, designed for rear camera of the smartphone. Wherein FIG. 2A exemplarily illustrates front view or displaying surface 201 of die webcam shield 200 for rear camera of the smartphone while FIG. 2B exemplarily illustrates rear view or the view of attachment surface 202 of the webcam shield 100 for rear camera of the smartphone which further includes; a shielding portion 203, a permanent attachment portion 204 and a permanent attachment member 205 same as the first exemplary embodiment.

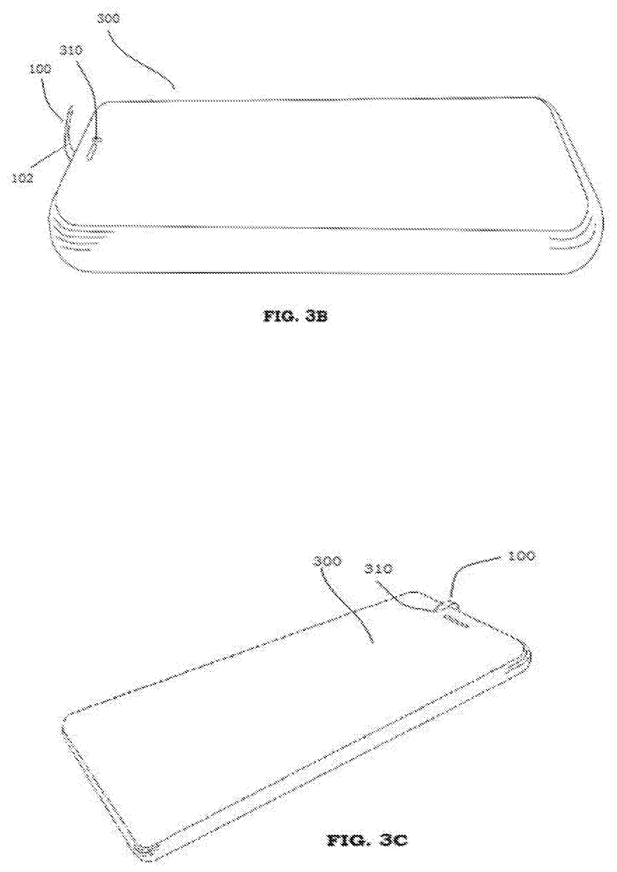

FIG. 3A in combination with FIG. 3B and FIG. 3C illustrates an exemplary attachment method of the webcam cover 100 over the front facing camera 310 of the smartphone 300, wherein the permanent attachment member of the webcam cover 100 is fixed in a range beside circumference of camera 310 of the smart phone 300 such that the shielding portion 103 of the permanent attachment surface 102 of webcam cover 100 can be detachably attached to the lens of the camera 310 to cover it when it is not in use. According to FIG. 3A, the permanent attachment portion 104 of the webcam cover is attached on rear-top surface of the smartphone 300 such that the shielding portion 103 of the permanent attachment surface 102 of webcam shield 100 covers the front view camera 310 of the smartphone 300. FIG. 3B shows a webcam shield 100 for front facing camera 310 in open position wherein the permanent attachment portion 104 of the shield 100 is attached permanent to the smartphone 300 while the shielding portion 103 of the shield 100 is in open position and not attached to the camera 310 of the smartphone 300 to allow user to use the camera 310. While FIG. 3C shows a webcam shield 100 for front facing camera 310 in closed position wherein the shielding portion 103 of the webcam shield 100 is detachably attached to the lens of the camera 310 using the Nano suction and static cling of the shielding portion 103 of the shield 100 to protect the webcam device from Camfecting.

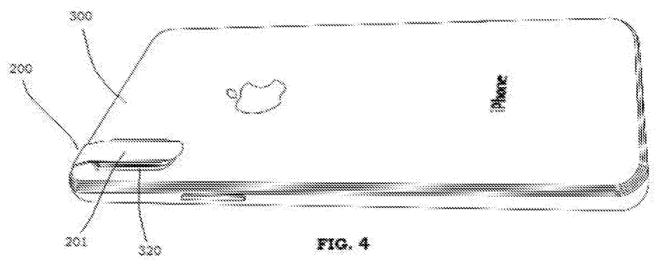

FIG. 4 illustrates another embodiment of the webcam shield 200 according to present invention attached to the rear camera 320 of the smart phone 300 in closed position. Wherein the attachment portion 203 of the permanent attachment surface 202 of webcam shield 200 is attached over the lens of rear camera 320 of the smartphone 300.

The foregoing disclosure is not intended to limit the present disclosure to the precise form or particular field of use disclosed. Abovementioned embodiments of the present invention are to be regarded as merely exemplary and can be used over any webcam device to protect it from camfecting and not limited to the smartphone only.

1. The webcam shield for the webcam devices comprising a main body having a displaying surface and an attachment surface wherein the attachment surface further comprises:
(a) A shielding portion,
(b) A permanent attachment portion; and
(c) A permanent attachment member.

2. The webcam cover according to claim 1, wherein the displaying surface of the shield may include any artistic design, image or picture, logo, name or quote, etc.

3. The webcam cover according to claim 1, wherein the shielding portion of the attachment surface includes Nano suctions or caters, which when pressed by user, creates partial vacuum between the shielding portion and the surface on which it is being attached.

4. The webcam shield according to claim 1, wherein the permanent attachment portion and shielding portion have different adhesive strengths.

5. The webcam shield according to claim 1, wherein the adhesive strength of permanent attachment portion is stronger than adhesive strength of shielding portion.

6. The webcam shield according to claim 1, wherein the shielding portion detachably attaches due to Nano-suctions while attachment portion permanently attaches using attachment member.

7. The webcam shield according to claim 1, wherein the attachment member is superimposed over the permanent attachment portion which allows permanent adherence of the webcam shield beside the circumference of lens of the camera.

8. The webcam shield according to claim 1, wherein the attachment member is any of double sided unconventional foam tape.

9. The webcam shield according to claim 8, wherein the double sided attachment member is configured to be attached to the webcam shield from one side and to the webcam device from the opposite side.

10. The webcam shield according to claim 8, wherein the webcam device attachment side of the attachment member further comprises a removable backing, releasably attached over it.

11. The webcam shield according to claim 9, wherein the webcam device is any of laptop, smartphone, tablet or any personal digital assistant.

12. The webcam shield according to claim 1, wherein the thickness of the webcam shield is 0.2 mm.

13. The webcam shield according to claim 1, wherein the webcam shield is made of polymer Nano-materials.

14. The webcam shield according to claim 1, wherein the webcam shield is sized to be fixed permanently around the perimeter of the lens of the camera with the shielding portion sized to extend across the lens of the camera.
